(19) United States
(12) Patent Application Publication
(10) Pub. No.: US 2010/0047634 A1
(43) Pub. Date: Feb. 25, 2010

(54) PORTABLE REFORMED FUEL CELL SYSTEMS WITH WATER RECOVERY

(75) Inventors: Hiep T. NGUYEN, San Francisco, CA (US); Ian W. KAYE, Livermore, CA (US); Jennifer E. BRANTLEY, Dublin, CA (US)

Correspondence Address: Beyer Law Group LLP, P.O. BOX 1687, Cupertino, CA, 95015-1687, US

(73) Assignee: ULTRACELL CORPORATION, Livermore, CA (US)

(21) Appl. No.: 12/347,626

(22) Filed: Dec. 31, 2008

Related U.S. Application Data
(60) Provisional application No. 61/019,919, filed on Jan. 9, 2008.

(51) Int. Cl. H01M 8/18

(52) U.S. Cl. 429/17; 429/20

(57) ABSTRACT

Described herein is a portable fuel cell system with water recovery capabilities. The system generates one or more exhaust streams from which water can be recovered. A water removal system contained in the portable fuel cell system package draws water from an exhaust stream; the exhaust may include a burner exhaust, a reformer exhaust, and/or a fuel cell exhaust. The water can then be provided to the incoming fuel.

### CROSS REFERENCE TO RELATED APPLICATIONS

This application claims priority under 35 U.S.C. §119(e) to U.S. Provisional Patent Application No. 61/019,919 filed on Jan. 9, 2008 entitled “PORTABLE REFORMED FUEL CELL SYSTEMS WITH WATER RECOVERY”, which is incorporated by reference herein for all purposes.

### GOVERNMENT RIGHTS

The invention described herein was made with Government support under Contract No. W909MY-08-C-0049 between the U.S. Army CECOM RDEC Power Technology Branch and UltraCell Corporation. The U.S. government has certain rights in this invention.

### FIELD OF THE INVENTION

The present invention relates to fuel cell technology. In particular, the invention relates to portable fuel cell systems that reform a fuel and transfer water from an exhaust stream to the incoming fuel.

### BACKGROUND OF THE INVENTION

Consumer electronics devices and other portable electrical power applications currently rely on lithium ion and similar battery technologies. A fuel cell electrochemically combines hydrogen and oxygen to produce electrical energy. Portable fuel cells that service portable electronics such as laptop computers would be desirable but are not yet commercially available.

Some larger and non-portable reformer based systems, which do not utilize molten carbonate (MCFC) and solid oxide (SOFC) fuel cells, rely on a water source to increase fuel efficiency. Stationary systems may employ standalone water treatment systems, or typically provide a condenser on the main exhaust; this condenses out water, which is then recycled back into the fuel stream. The goal in adding such water recovery systems is to reduce the cost of the clean water. The capital costs for a stand alone water treatment system may be excessive.

For a stationary condenser, when the ambient temperature is greater than approximately 40° Celcius (C.), the condenser typically cannot cool enough water and recycle it back into the fuel stream. For water recovery to be a viable component in portable fuel cell technology, it should be able to operate at an ambient temperature greater than 40° C.

Furthermore, using a standard condenser imposes orientation specific requirements to the system, since condensers typically separate liquid and vapor phases by means of gravity. Thus, standard condensers are not able to work in portable packages that offer different orientations such as when positioned on its side, upside-down, or any other varying orientation.

Other current water recovery techniques in the fuel cell space utilize traditional air-fin heat exchangers to condense water from fuel cell exhaust in a direct methanol fuel cell system. However, the traditional air-fin heat exchangers do not operate under high ambient temperatures and their condensing units are not orientation independent, which is not suitable for portable fuel cell systems. Furthermore, condensing systems may have liquid water present and if subjected to sub-zero storage, internal plumbing and other components may be damaged due to ice formation.

### OVERVIEW

A portable fuel cell system for producing electrical energy included in a portable package has a fuel processor including: a) a reformer configured to receive fuel and to output hydrogen and reformer exhaust, and b) a burner configured to receive fuel, to generate heat using the fuel, and to output burner exhaust. The package also has a fuel cell configured to produce electrical energy using hydrogen output by the reformer. The fuel cell system also has at least one fuel line, internal to the portable package, configured to transport fuel to the reformer or burner, and a water removal system including: a) a water permeable membrane configured to receive an exhaust and configured to remove water from the exhaust, and b) a condensing apparatus including a condenser and a wick, the condensing apparatus configured to receive the exhaust after the water permeable membrane and configured to remove water from the exhaust. The fuel cell system also has at least one water line, internal to the portable package, configured to transport the water removed by the water permeable membrane and the condensing apparatus to the at least one fuel line, wherein the removed water is added to the fuel.
In another embodiment, the portable fuel cell system has a) a reformer configured to receive fuel and to output hydrogen using the fuel source, and b) a burner configured to receive fuel, to generate heat using the fuel, and to output burner exhaust. The fuel cell system also has a fuel cell configured to produce electrical energy using hydrogen output by the reformer, at least one fuel line internal to the portable package and configured to transport fuel to the reformer or burner, and a water removal system. The water removal system includes a) a water permeable membrane configured to receive the burner exhaust and configured to remove water from the burner exhaust, and b) a condensing apparatus including a condenser and a wick, the condensing apparatus configured to receive the burner exhaust after the water permeable membrane and configured to remove water from the burner exhaust. The fuel cell system further has at least one water line, internal to the portable package, configured to transport the water removed by the water permeable membrane and the condensing apparatus to the at least one fuel line, wherein the removed water is added to the fuel.

A method for recovering water in a portable fuel cell system is also provided. The method comprises providing burner fuel to a burner in a fuel processor, generating heat in the burner using the burner fuel, providing reformer fuel to a reformer in the fuel processor, reforming the reformer fuel provided to the reformer to produce hydrogen, generating electrical energy in a fuel cell using hydrogen produced by the fuel processor, removing water from an exhaust with a water removal system that includes a water permeable membrane and a condensing apparatus, the water permeable membrane configured to receive the exhaust and configured to remove water from the exhaust, and the condensing apparatus including a condenser and a wick and configured to remove water from the exhaust after the water permeable membrane has removed water from the exhaust, and adding the removed water to a fuel line before fuel in the fuel line reaches the reformer or the burner.

In another example, a program storage device readable by a machine tangibly embodying a program of instructions executable by the machine to perform a method for recovering water in a portable fuel cell system, the method comprising providing burner fuel to a burner in a fuel processor, generating heat in the burner using the burner fuel, providing reformer fuel to a reformer in the fuel processor, reforming the reformer fuel provided to the reformer to produce hydrogen, generating electrical energy in a fuel cell using hydrogen produced by the fuel processor, removing water from an exhaust with a water removal system that includes a water permeable membrane and a condensing apparatus, the water permeable membrane configured to receive the exhaust and configured to remove water from the exhaust, and the condensing apparatus including a condenser and a wick and configured to remove water from the exhaust after the water permeable membrane has removed water from the exhaust, and adding the removed water to a fuel line before fuel in the fuel line reaches the reformer or the burner.

The present invention provides other hardware configured to perform the methods of the invention, as well as software stored in a machine-readable medium (e.g., a tangible storage medium) to control devices to perform these methods. These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

FIG. 1A illustrates a fuel cell package in accordance with one embodiment.

FIG. 1B illustrates an example schematic operation for the fuel cell system of FIG. 1A.

FIGS. 2A-2B illustrate fuel cell systems having example water removal systems that receive burner exhaust.

FIGS. 3A and 3B illustrate fuel cell systems having example water removal systems that receive fuel cell exhaust.

FIG. 4 illustrates a fuel cell system having an example water removal system that receives cathode exhaust.

FIG. 5 illustrates a fuel cell system having another example water removal system.

FIG. 6 illustrated an example portable fuel cell system.

FIGS. 7A and 7B are flow diagrams of a method for recovering water in a portable fuel cell system.

FIG. 8 is a graph illustrating the days of run time from a single 200 cc cartridge.

FIG. 9 shows a method for steady state operation and electrical energy generation of a portable fuel cell system in accordance with one embodiment.

FIG. 10 shows a method for warm-up operation of a fuel cell system in accordance with another embodiment.

FIGS. 11A-11C show three stages of fuel cell warm-up according to a specific embodiment of FIG. 10.

FIG. 12 illustrates an example computer system suitable for implementing the software applications used in one or more embodiments of the water recovery system.

### DESCRIPTION OF EXAMPLE EMBODIMENTS

Embodiments are described herein in the context of portable reformed fuel cell systems with water recover. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Water recovery in a portable fuel cell system provides increased energy density of the fuel and allows a given fuel cartridge to power a portable system for longer durations. To increase the energy density of the fuel, systems and methods described herein recycle product water from an exhaust back to a fuel inlet, thereby reducing the amount of water in the fuel cartridge and resulting in: a) more fuel in the same fuel container and b) increased energy density of the fuel. This allows a portable fuel cell system to run for longer durations using the same sized fuel container. A water removal system in the portable fuel cell system is used to remove the water from exhausts in the fuel cell system and the water is then recovered for use in the portable fuel cell system.

In one embodiment, the water recovery system described herein is orientation independent, meaning that the portable package containing the water removal system can be turned upside down or in any direction relative to the ground and forces of gravity. The water recovery system also provides robust temperature operation. In a specific embodiment, the water removal system is capable of operating at ambient temperatures greater than 55 degrees Celsius, can be stored at below freezing temperatures. The higher fuel energy density may also increase the fuel cell system start up and run time. Sample portable fuel cell systems will initially be described. Other fuel cell systems may also be used.

Fuel Cell Systems

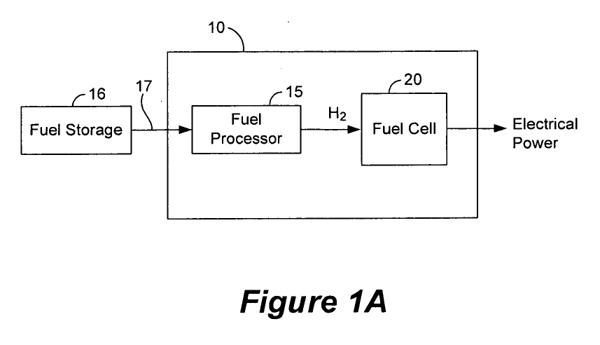

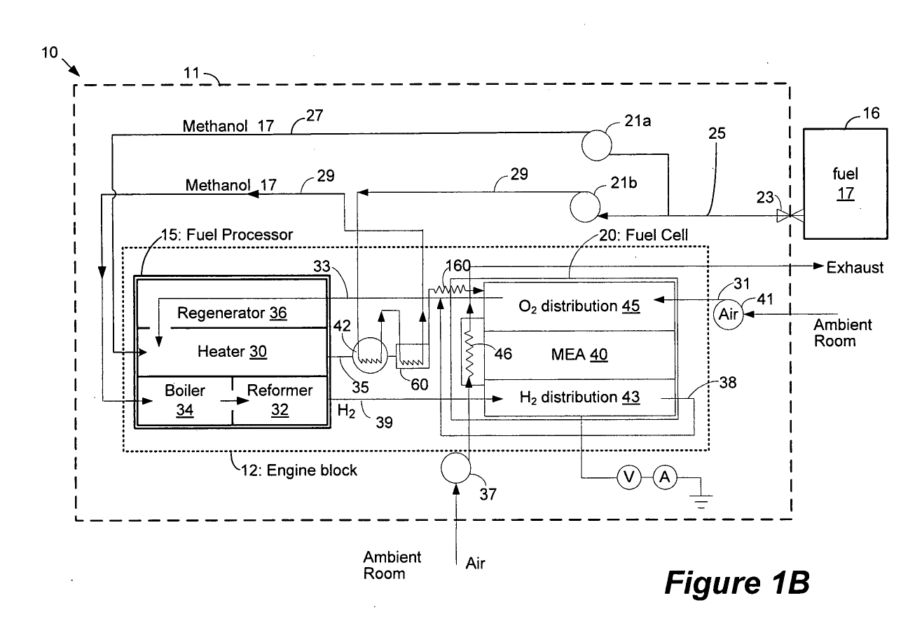

Fuel cell systems that benefit from embodiments described herein will first be described. FIG. 1A illustrates a fuel cell system 10 for producing electrical energy in accordance with one embodiment. As shown, ‘reformed’ hydrogen system 10 includes a fuel processor 15 and fuel cell 20, with a fuel storage device 16 coupled to system 10 for fuel provision. System 10 processes a fuel 17 to produce hydrogen for fuel cell 20. The system may be included in a portable electronics device such as a portable generator, a battery charger, portable computer, a hybrid energy storage device such as a fuel cell/battery combination device, and thus include controls and components to operate the device.

Storage device, or cartridge, 16 stores a fuel 17, and may comprise a refillable and/or disposable device. Either design permits recharging capability for system 10 or an electronics device using the output electrical power by swapping a depleted cartridge for one with fuel. A connector on cartridge 16 interfaces with a mating connector on system 10 or the electronics device to permit fuel transfer from the cartridge. In a specific embodiment, cartridge 16 includes a bladder that contains the fuel 17 and conforms to the volume of fuel in the bladder. An outer rigid housing of device 16 provides mechanical protection for the bladder. The bladder and housing permit a wide range of cartridge sizes with fuel capacities ranging from a few milliliters to several liters. In one embodiment, the cartridge is vented and includes a small hole, single direction flow valve, hydrophobic filter, or other aperture to allow air to enter the fuel cartridge as fuel 17 is consumed and displaced from the cartridge. In another specific embodiment, the cartridge includes ‘smarts’, or a digital memory used to store information related to usage of device 16.

A pressure source moves fuel 17 from storage device 16 to fuel processor 15. In a specific embodiment, a pump in system 10 draws fuel from the storage device. Cartridge 16 may also be pressurized with a pressure source such as compressible foam, spring, or a propellant internal to the housing that pushes on the bladder (e.g., propane, dimethyether (DME), liquid carbon dioxide or compressed nitrogen gas). In this case, a control valve in system 10 regulates fuel flow. Other fuel cartridge designs suitable for use herein may include a wick that moves a liquid fuel from within cartridge 16 to a cartridge exit. If system 10 is load following, then a sensor meters fuel delivery to processor 15, and a control system in communication with the sensor regulates the fuel flow rate as determined by a desired power level output of fuel cell 20.

Fuel 17 acts as a carrier for hydrogen and can be processed or manipulated to separate hydrogen. The terms ‘fuel’, ‘fuel source’ and ‘hydrogen fuel source’ are interchangeable herein and all refer to any fluid (liquid or gas) that can be manipulated to separate hydrogen. Liquid fuels 17 offer high energy densities and the ability to be readily stored and shipped. Fuel 17 may include any hydrogen bearing fuel stream, hydrocarbon fuel or other source of hydrogen such as ammonia. Currently available hydrocarbon fuels 17 suitable for use with system 10 include gasoline, diesel, JP8, JP5, C₁ to C₄ hydrocarbons, their oxygenated analogues and/or their combinations, for example. Other fuel sources may be used with system 10, such as sodium borohydride. Several hydrocarbon and ammonia products may also be used.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1%-99.9%. Other liquid fuels such as butane, butanol, propanol, propane, gasoline, military grade “JP8”, and the like may also be contained in storage device 16 with concentrations in water from 5%-100%. In a specific embodiment, fuel 17 comprises between about 40% and about 85% methanol by volume. In a specific embodiment, fuel 17 comprises 67% methanol by volume. In another specific embodiment, fuel 17 comprises pure methanol.

Fuel processor 15 receives methanol 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. Those of skill in the art will understand that the fuel may be mixed with air in a catalytic partial oxidizer (CPOX), or additional steam added and the reactants fed into an auto thermal reformer (ATR), or the reformer may be fed with a mixture of fuel and water (e.g. such as from a steam reformer). As the term is used herein, reforming refers to the process of producing hydrogen from a fuel 17. Fuel processor 15 may output either pure hydrogen or a hydrogen-bearing gas stream (also commonly referred to as ‘reformate’).

Various types of reformers are suitable for use in fuel cell system 10; these include steam reformers, auto thermal reformers (ATR) and catalytic partial oxidizers (CPOX) for example. A steam reformer only needs steam and fuel to produce hydrogen. ATR and CPOX reformers mix air with a fuel/steam mixture. ATR and CPOX systems reform fuels such as methanol, diesel, regular unleaded gasoline and other hydrocarbons. In a specific embodiment, storage device 16 provides methanol 17 to fuel processor 15, which reforms the methanol at about 280 degrees Celsius or less and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct.

In one embodiment, fuel cell 20 is a low volume ion conductive membrane (PEM) fuel cell suitable for use with portable applications and consumer electronics. A PEM fuel cell comprises a membrane electrode assembly (MEA) that carries out the electrical energy generating an electrochemical reaction. The MEA includes a hydrogen catalyst, an oxygen catalyst, and an ion conductive membrane that a) selectively conducts protons and b) electrically isolates the hydrogen catalyst from the oxygen catalyst. One suitable MEA is model number CELTEC P1000 as provided by BASF Fuel Cells of Frankfurt, Germany. A hydrogen gas distribution layer may also be included. It contains the hydrogen catalyst and allows the diffusion of hydrogen therethrough. An oxygen gas distribution layer contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, a PEM fuel cell includes a fuel cell stack having a set of bi-polar plates. In a specific embodiment, each bi-polar plate is formed from a thin single sheet of metal that includes channel fields on opposite surfaces of the metal sheet. Thickness for these plates is typically below about 5 millimeters, and compact fuel cells for portable applications may employ plates thinner than about 2 millimeters. In a specific embodiment, the thickness of the bi-polar plate is less than 0.5 millimeters. The single bi-polar plate thus dually distributes hydrogen and oxygen; one channel field distributes hydrogen while a channel field on the opposite surface distributes oxygen and the bulk material between the two channel fields acts as a lateral heat transfer mechanism. In another embodiment, each bi-polar plate is formed from multiple layers that include more than one sheet of metal. Multiple bi-polar plates can be stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MEA occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Many designs employ a rough and porous catalyst to increase surface area of the platinum exposed to the hydrogen and oxygen. A fuel cell suitable for use herein is further described in commonly owned patent application Ser. No. 11/120,643 and entitled “Compact Fuel Cell Package”, which is incorporated by reference in its entirety for all purposes.

Since the electrical generation process in fuel cell 20 is exothermic, fuel cell 20 may implement a thermal management system to dissipate heat. Fuel cell 20 may also employ a number of humidification plates (HP) to manage moisture levels in the fuel cell.

While system 10 will mainly be discussed with respect to PEM fuel cells, it is understood that system 10 may be practiced with other fuel cell architectures. The main difference between fuel cell architectures is the type of ion conductive membrane used. In another embodiment, fuel cell 20 is phosphoric acid fuel cell that employs liquid phosphoric acid for ion exchange. Solid oxide fuel cells employ a hard, non-porous ceramic compound for ion exchange and may be suitable for use with embodiments described herein. Other suitable fuel cell architectures may include alkaline and molten carbonate fuel cells, for example.

FIG. 1B illustrates an example schematic operation for the fuel cell system 10 of FIG. 1A. Fuel cell system 10 is included in a portable package 11. In this case, package 11 includes fuel cell 20, fuel processor 15, and all other balance-of-plant components except cartridge 16. As the term is used herein, a fuel cell system package 11 refers to a fuel cell system that receives a fuel and outputs electrical energy. At a minimum, this includes a fuel cell and fuel processor. The package need not include a cover or housing, e.g., in the case where a fuel cell, or a fuel cell and fuel processor, is included in a battery bay of a laptop computer or other device which requires portable power such as remote sensors or transmitters. In this case, the portable fuel cell system package 11 only includes the fuel cell, or fuel cell and fuel processor, and no housing. The package may include a compact profile, low volume, or low mass—any of which is useful in any power application where size is relevant.

An outlet of storage device 16 includes a connector 23 that couples to a mating connector on package 11. In a specific embodiment, connector 23 and mating connector form a quick connect/disconnect for easy replacement of cartridges 16. The mating connector communicates methanol 17 into hydrogen fuel line 25, which is internal to package 11.

Line 25 divides into two lines: a first line 27 that transports methanol 17 to a burner/heater 30 for fuel processor 15 and a second line 29 that transports methanol 17 for a reformer 32 in fuel processor 15. Lines 25, 27 and 29 may comprise channels disposed in the fuel processor (e.g., channels in one or more metal components) and/or tubes leading thereto.

As the term is used herein, a line refers to one or more conduits or channels that communicate a fluid (a gas, liquid, or combination thereof). For example, a line may include a separable plastic conduit. In a specific embodiment to reduce package size, the fuel cell and the fuel processor may each include a molded channel dedicated to the delivering hydrogen from the processor to the cell. The channeling may be included in a structure for each. When the fuel cell attaches directly to the fuel processor, the hydrogen transport line then includes a) channeling in the fuel processor to deliver hydrogen from a reformer to the connection, and b) channeling in the fuel cell to deliver the hydrogen from the connection to a hydrogen intake manifold. An interconnect may also facilitate connection between the fuel cell and the fuel processor. The interconnect includes an integrated hydrogen conduit dedicated to hydrogen transfer from the fuel processor to the fuel cell. Other plumbing techniques known to those of skill in the art may be used to transport fluids in a line.

Flow control is provided on each line 27 and 29. In this embodiment, separate pumps 21a and 21b are provided for lines 27 and 29, respectively, to pressurize each line separately and transfer methanol at independent rates, if desired. A model 030SP-S6112 pump as provided by Biochem, NJ is suitable to transmit liquid methanol on either line in a specific embodiment. A peristaltic, electro-osmotic, diaphragm or piezoelectric pump is also suitable for use with system 10. A flow restriction may also be provided on each line 27 and 29 to facilitate sensor feedback and flow rate control. In conjunction with suitable control, such as digital control applied by a processor that implements instructions from stored software, each pump 21 responds to control signals from the processor and moves a desired amount of methanol 17 from storage device 16 to heater 30 and reformer 32 on each line 27 and 29.

Air source 41 delivers oxygen and air from the ambient room through line 31 to the cathode in fuel cell 20, where some oxygen is used in the cathode to generate electricity. Air source 41 may include a pump, fan, blower, or compressor, for example. Low pressure airflow embodiments are also contemplated.

High operating temperatures in fuel cell 20 also heat the oxygen and air. In the embodiment shown, the heated oxygen and air is then transmitted from the fuel cell, via line 33, to a regenerator 36 (also referred to herein as a ‘dewar’) of fuel processor 15, where the air is additionally heated (by escaping heat from heater 30) before the air enters heater 30. This double pre-heating increases efficiency of fuel cell system 10 by a) reducing heat lost to reactants in heater 30 (such as fresh oxygen that would otherwise be near room temperature when combusted in the heater), and b) cooling the fuel cell during energy production. In a specific embodiment, a model BTC compressor as provided by Hargraves, NC is suitable to pressurize oxygen and air for fuel cell system 10. Other air moving devices such as fans, blowers, gerotor compressors, and the like, are also suitable.

When fuel cell cooling is needed, a fan 37 blows air from the ambient room over fuel cell 20. Fan 37 may be suitably sized to move air as desired by the heating requirements of fuel cell 20; many vendors known to those of skill in the art provide fans and blowers suitable for use with package 10.

Fuel processor 15 is configured to process fuel 17 and output hydrogen. Fuel processor 15 comprises heater 30, reformer 32, boiler 34, and regenerator 36. Heater 30 (also referred to herein as a burner when it uses catalytic combustion to generate heat) includes an inlet that receives methanol 17 from line 27. In a specific embodiment, the burner includes a catalyst that helps generate heat from methanol, such as platinum or palladium coated onto a suitable support or alumina pellets for example.

In a specific embodiment, heater 30 includes its own boiler to preheat fuel for the heater. Boiler 34 includes a chamber having an inlet that receives methanol 17 from line 29. The boiler chamber is configured to receive heat from heater 30, via heat conduction through one or more walls between the boiler 34 and heater 30, and use the heat to boil the methanol passing through the boiler chamber. The structure of boiler 34 permits heat produced in heater 30 to heat methanol 17 in boiler 34 before reformer 32 receives the methanol 17. In a specific embodiment, the boiler chamber is sized to boil methanol before receipt by reformer 32. Boiler 34 includes an outlet that provides heated methanol 17 to reformer 32.

Reformer 32 includes an inlet that receives heated methanol 17 from boiler 34. A catalyst in reformer 32 reacts with the methanol 17 to produce hydrogen and carbon dioxide; this reaction is endothermic and draws heat from heater 30. A hydrogen outlet of reformer 32 outputs hydrogen to line 39. In one embodiment, fuel processor 15 also includes a preferential oxidizer that intercepts reformer 32 hydrogen exhaust and decreases the amount of carbon monoxide in the exhaust. The preferential oxidizer employs oxygen from an air inlet to the preferential oxidizer and a catalyst, such as ruthenium that is preferential to carbon monoxide over hydrogen.

Regenerator 36 pre-heats incoming air before the air enters heater 30. In one sense, regenerator 36 uses outward traveling waste heat in fuel processor 15 to increase thermal management and thermal efficiency of the fuel processor. Specifically, waste heat from heater 30 pre-heats incoming air provided to heater 30 to reduce heat transfer to the air within the heater. As a result, more heat transfers from the heater to reformer 32. The regenerator also functions as insulation. More specifically, by reducing the overall amount of heat loss from fuel processor 15, regenerator 36 also reduces heat loss from package 11. This enables a cooler fuel cell system 10 package.

In one embodiment, fuel processor 15 includes a monolithic structure having common walls between the heater 30 and other chambers in the fuel processor. Fuel processors suitable for use herein are further described in commonly owned patent application Ser. No. 10/877,044, entitled “Annular Fuel Processor And Methods” which is incorporated by reference in its entirety for all purposes.

Line 39 transports hydrogen and reformer exhaust (or ‘reformate’) from fuel processor 15 to fuel cell 20. The reformed exhaust includes water, typically in vapor form due to the elevated operating temperature of the fuel processor. In a specific embodiment, gaseous delivery lines 33, 35 and 39 include channels in a metal interconnect that couples to both fuel processor 15 and fuel cell 20. A hydrogen flow sensor (not shown) may also be added on line 39 to detect and communicate the amount of hydrogen being delivered to fuel cell 20. In conjunction with the hydrogen flow sensor and suitable control, such as digital control applied by a processor that implements instructions from stored software, system 10 regulates hydrogen gas provision to fuel cell 20.

Fuel cell 20 includes a hydrogen inlet port that receives hydrogen from line 39 and includes a hydrogen intake manifold that delivers the gas to one or more bi-polar plates and their hydrogen distribution channels. An oxygen inlet port of fuel cell 20 receives oxygen from line 31; an oxygen intake manifold receives the oxygen from the port and delivers the oxygen to one or more bi-polar plates and their oxygen distribution channels. A cathode exhaust manifold collects gases from the oxygen distribution channels and delivers them to a cathode exhaust port and line 33, or to the ambient room. An anode exhaust manifold 38 collects gases from the hydrogen distribution channels, and in one embodiment, delivers the gases to the ambient room.

In a specific embodiment, and as shown, the anode exhaust is transferred back to fuel processor 15. In this case, system 10 comprises plumbing 38 that transports unused hydrogen from the anode exhaust to heater 30. For system 10, heater 30 includes two inlets: an inlet configured to receive fuel 17 and an inlet configured to receive hydrogen from line 38. Heater 30 then includes a thermal catalyst that reacts with the unused hydrogen to produce heat. Since hydrogen consumption within a PEM fuel cell 20 is often incomplete and the anode exhaust often includes unused hydrogen, re-routing the anode exhaust to heater 30 allows a fuel cell system to capitalize on unused hydrogen and increase hydrogen usage and energy efficiency. The fuel cell system thus provides flexibility to use different fuels in a catalytic heater 30. For example, if fuel cell 20 can reliably and efficiently consume over 90% of the hydrogen in the anode stream, then there may not be sufficient hydrogen to maintain reformer and boiler operating temperatures in fuel processor 15. Under this circumstance, methanol supply is increased to produce additional heat to maintain the reformer and boiler temperatures. In one embodiment, gaseous delivery in line 38 back to fuel processor 15 relies on pressure at the exhaust of the anode gas distribution channels, e.g., in the anode exhaust manifold. In another embodiment, an anode recycling pump or fan is added to line 38 to pressurize the line and return unused hydrogen back to fuel processor 15. The unused hydrogen is then combusted for heat generation.

In one embodiment, fuel cell 20 includes one or more heat transfer appendages 46 that permit conductive heat transfer with internal portions of a fuel cell stack. This may be done for heating and/or cooling fuel cell 20. In a specific heating embodiment, exhaust 35 of heater 30 is transported to the one or more heat transfer appendages 46 during system start-up to expedite reaching initial elevated operating temperatures in fuel cell 20. The heat may come from hot exhaust gases or unburned fuel in the exhaust, which then interacts with a catalyst disposed on or in proximity with a heat transfer appendage 46. In a specific cooling embodiment, fan 37 blows cooling air over the one or more heat transfer appendages 46, which provides dedicated and controllable cooling of the stack during electrical energy production. Fuel cells suitable for use herein are further described in commonly owned patent application Ser. No. 10/877,770, entitled “Micro Fuel Cell Thermal Management” which is incorporated by reference in its entirety for all purposes.

In one embodiment, system 10 increases thermal and overall energy efficiency of a portable fuel cell system by using waste heat in the system to heat incoming reactants such as an incoming fuel or air. To this end, the embodiment in FIG. 1B includes heat exchanger, or recuperator, 42.

Heat exchanger or recuperator 42 transfers heat from fuel cell system 10 to the inlet fuel 17 before the methanol reaches fuel processor 15. This increases thermal efficiency for system 10 by preheating the incoming fuel (to reduce heating of the fuel in heater 30) and reuses heat that would otherwise be expended from the system. While system 10 shows heat exchanger 42 heating methanol in line 29 that carries fuel 17 to the boiler 34 and reformer 32, it is understood that heat exchanger 42 may be used to heat methanol in line 27 that carries fuel 17 to burner 30.

Heat exchanger 42 may include any device configured to transfer heat produced in fuel cell system 10, or from a fluid heated in fuel cell system 10 and used as a carrier of the heat, to an incoming reactant such as fuel 17 or air. Heat exchanger 42 may rely on conductive heat transfer, convective heat transfer, and combinations thereof. Heat exchanger 42 may include one or more heat transfer channels for moving the incoming fuel 17, moving the heating medium, and one or more surfaces or structures for transferring heat from the heating medium to the incoming fuel 17. In one embodiment, heat exchanger 42 includes a commercially available heat exchanger.

Heat exchanger 42 may be in thermal communication with a water recover system 60 as further discussed in detail below.

In addition to the components shown in shown in FIG. 1B, system 10 may also include other elements such as electronic controls, additional pumps and valves, added system sensors, manifolds, heat exchangers and electrical interconnects useful for carrying out functionality of a fuel cell system 10 that are known to one of skill in the art and omitted for sake of brevity. FIG. 1B shows one specific plumbing arrangement for a fuel cell system; other plumbing arrangements are suitable for use herein. For example, the heat transfer appendages 46, a heat exchanger and dewar 36 need not be included. Other alterations to system 10 are permissible, as one of skill in the art will appreciate.

System 10 generates DC voltage, and is suitable for use in a wide variety of portable applications. For example, electrical energy generated by fuel cell 20 may power a notebook computer 11 or a portable electrical generator 11 carried by military personnel.

In one embodiment, system 10 provides portable, or ‘small’, fuel cell systems that are configured to output less than 250 watts of power (net or total). Fuel cell systems of this size are commonly referred to as ‘micro fuel cell systems’ and are well suited for use with portable electronics devices. In one embodiment, the fuel cell is configured to generate from about 1 milliwatt to about 200 Watts. In another embodiment, the fuel cell generates from about 5 Watts to about 60 Watts. Fuel cell system 10 may be a stand-alone system, which is a single package 11 that produces power as long as it has access to a) oxygen and b) hydrogen or a fuel such as a hydrocarbon fuel. One specific portable fuel cell package produces about 20 Watts or about 65 Watts, depending on the number of cells in a stack for fuel cell 20 and the amount of catalyst in the fuel processor reformer and burner reactors.

In addition to power capacity, portable fuel cell system 10 may also be characterized by its size or power density. Volume may characterize package 11, where the volume includes all components of the package 11 used in system 10, except the external storage device 16, whose size may change. In a specific embodiment, package 11 has a total volume less than about a liter. In a specific embodiment, package 11 has a total volume less than about ½ liter. Greater and lesser package volumes may be used with system 10 with up to several liters in volume.

Portable package 11 also includes a relatively small mass. In one embodiment, package 11 has a total mass less than about a 1 kilogram. In a specific embodiment, package 11 has a total volume less than about ½ kilogram. Greater and lesser package masses are permissible. Depending on the power level, the system mass may be up to about 10 kilograms.

Power density may also be used to characterize system 10 or package 11. Power density refers to the ratio of electrical power output provided by a fuel cell system included relative to a physical parameter such as volume or mass of package 11. Notably, fuel cell systems described herein provide fuel cell packages with power densities not yet attained in the fuel cell industry. In one embodiment, fuel cell package 11 provides a power density of greater than about 40 Watts/liter. This package includes all balance of plant items (cooling system, power conversion, start-up battery, and others items) except the fuel and fuel source storage device 16. In another specific embodiment, fuel cell package 11 provides a power density of greater than about 80 Watts/liter. A power density from about 45 Watts/liter to about 90 Watts/liter works well for many portable applications. Greater and lesser power densities are also permissible.

Fuel Cell System Water Recovery System

Water recovery systems described herein permit less water in a fuel container, which increases energy density of the fuel and increases energy storage in the fuel container. Reformed methanol fuel cell (RMFC) technology is designed to produce hydrogen from a mixture of water and methanol. A steam/carbon ratio of 1.1:1 (˜67% methanol) is suitable for some systems. One suitable overall reaction for a reformer is:

CH₃OH+1.1H₂O→3H₂+CO₂+0.1H₂ (1)

From the equation above, water is actually part of the fuel. About one-third of the generated hydrogen comes from the water.

Pure methanol, however, has a higher heating value than a water/methanol mixture. Thus, using pure methanol should increase the energy density of the fuel. In a specific embodiment, a portable fuel cell system described herein may use neat fuel that is undiluted with reactant water, such as pure methanol or the like. Eliminating all water from the fuel, however, may result in less hydrogen and more carbon monoxide as illustrated in the following reaction:

CH₃OH→2H₂+CO (2)

For fuel cells operating below about 500° C., carbon monoxide is typically not a suitable fuel. Therefore, in order to get the maximum energy density out of methanol water is added to the fuel.

Water recovery systems described herein remove water from one or more exhaust streams in the portable fuel cell system. The water may be generated at a cathode of the fuel cell, a reformer in the fuel processor, or a catalytic heater in the fuel processor.

In many cases, all the elemental hydrogen entering the system, either in hydrocarbon fuel, pure hydrogen, ammonia, or other mixtures, eventually exits the system as product water. Removing this product water and recycling it back into the incoming fuel allows the system to gain the benefits of higher energy density fuel and the additional hydrogen generated by the shift reaction of carbon monoxide via the following reaction:

CO+H₂O→CO₂+H₂ (3)

The recovery of water may increase efficiency of a fuel processor by between about 5% to about 10% and reduce fuel consumption in the burner. Additionally, the fuel processor increased efficiency may yield about 180 Whr/Kg increase in energy density. Thus, recovering water as described herein reduces the amount of water that must be carried by the fuel cartridge.

In one embodiment, the water removal system includes a water permeable membrane and a condensing apparatus. The water permeable membrane receives an exhaust and removes water from the exhaust. The water permeable membrane transfers water from one fluid (liquid or gas) to a second fluid. The water removed may be in any state such as a liquid state, vapor state, or a mixture thereof. The water permeable membrane includes a membrane that is permeable to the water. The fluid stream to be humidified (the dry stream) is directed over one side of the membrane while the fluid stream supplying the water (the wet stream) is directed over the opposing side of the membrane. The terms “dry” and “wet” in this instance are relative terms; “dry” does not necessarily mean the complete absence of water, and “wet” does not necessarily mean saturation with water.

The membrane may have a microporous polymer and a hydrophilic additive. The hydrophilic material may attract water and allows the water to flow through either as a gas or liquid, yet blocks out other gasses such as carbon dioxide, methanol, or the like. The hydrophilic material may be any material that is stable at high temperatures greater than 150° C. such as porous steel, polymers (Acrylonitrile-butadiene-styrene terpolymer (ABS), polypropylene, and the like), aluminum, and the like. For example, metal and ceramic matrix membranes made by Aspen Systems Inc, of Marlborough, Mass., may be used.

In operation, the membrane has favorable water transmission properties and resists transmission of reactant gases or other components. The membrane is also permeable, in a dry condition, to the wet or dry gases in the water permeable membrane, and/or when the wet and dry gases are of different composition. By wetting the membrane, the presence of an amount of liquid water in the wet gas can reduce gas transmission through the membrane to an acceptable level.

The condensing apparatus includes a condenser and a wick. The condensing apparatus receives the exhaust after the water permeable membrane and removes water from the exhaust. The condenser condenses the water vapor in the exhaust to liquid and the wick collects and removes the liquid water.

Furthermore, in a specific embodiment, the water permeable membrane is selectively permeable or diffusing. Methanol and water have high affinity for each other. Thus, the water permeable membrane may be configured such that it preferably diffuses water vapor from the water rich side into the methanol rich side, without allowing for methanol to diffuse from the methanol rich side into the water rich side (the natural concentration gradient).

Additionally, for portable systems, the water permeable membrane and wick both offer a water recovery capability that is orientation independent, and ensures that the removed water goes to the correct location.

Several sample water recovery embodiments are discussed below. A simplified RMFC system diagram is provided as a sample, however a more advanced system may be used. Additionally, other reformed hydrocarbon fuels such as DME, propane, methane, butane, gasoline, diesel, ethanol, and the like may be used. Depending on the fuel, different amounts of water may be recycled back and added to the fuel. For example, reformed methane typically requires a steam to carbon ratio of 3, while DME requires a steam to carbon ratio of about 1.5 to 1.7.

In each of the examples discussed below, the water permeable membrane is plumbed such that its “hot” side is on the water (vapor, liquid, or 2-phase) carrying stream and the “cold” side is on the methanol side. Other fuels, as listed above, may also be used.

Referring back to FIG. 1B, the fuel cell system has a water removal system 60 configured to receive burner exhaust 35. The water removal system 60 has a hot side inlet located downstream the recuperator 42 hot side exhaust. The water removal system 60 also has a cold side inlet located downstream of the recuperator 42 cold side outlet. In this case, the burner 30 exhaust feeds into the recuperator 42, where it cools down and helps boil incoming methanol fuel. The burner 30 exhaust stream then proceeds into the water removal system 60. Also, the methanol fuel first enters the recuperator 42, is boiled, and then enters the water removal system 60. On the water removal system 60 cold inlet side, the methanol may be fully vaporized, while on the hot side, the available water remains in a vapor phase and may be recovered by the water permeable membrane 60. Thus, as methanol passes through the water removal system 60 from the cold side to the hot side, the resulting mixture is a substantially single-phase vapor mixture of water and methanol vapors.

In another embodiment, the water removal system 60 is in thermal communication with the fuel cell 20 using a heat sink, heap pipe 160, or other heat transfer means. This allows the water removal system 60 to maintain temperature even in the presence of heat losses, thereby preventing condensation in the cold side of the water removal system 60. There is no phase change of either water or methanol, which may increase the lifetime of the water removal system 60. Phase change, especially from liquid to vapor can result in un-predictable expansion or contractions analogous to cavitation.

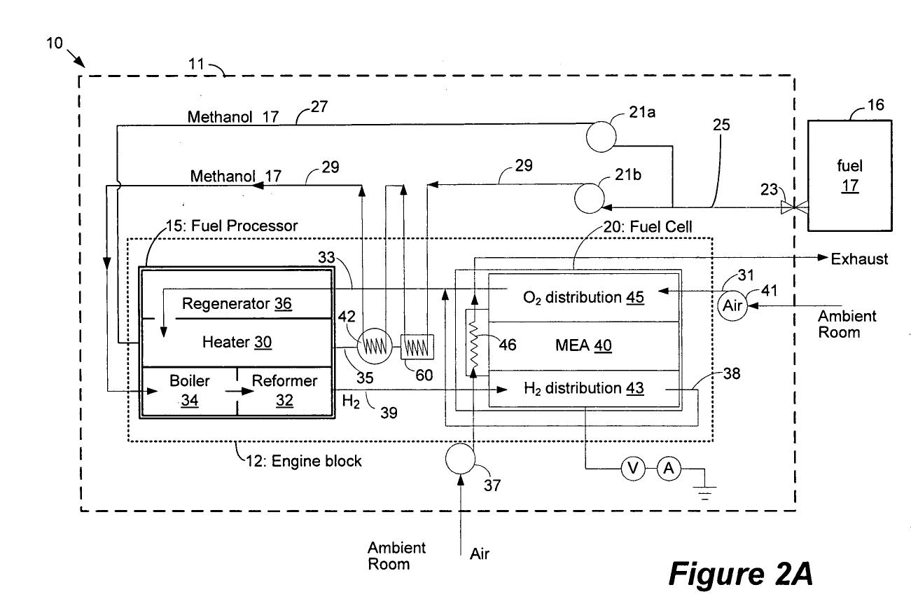

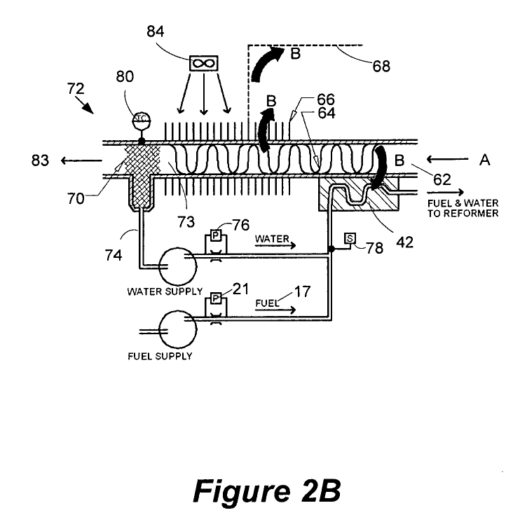

FIGS. 2A and 2B illustrate fuel cell systems having example water recover systems that receive burner exhaust. Referring to FIG. 2A, fuel processor 15 outputs exhaust from the burner 30 (line 35) or the reformer 32 (line 39). As illustrated, the recuperator 42 receives exhaust from the burner 30. However, this is not intended to be limiting since the recuperator 42 can also receive exhaust from the reformer 32. The recuperator 42 can cool the hot side of the water removal system 60 to a temperature of between about 100° C. to about 150° C. The exhaust output from the recuperator 42 contains a high percentage of water vapor (for example, between about 10% to about 25% mole fraction), which may be removed by the water removal system 60. The water removal system 60 receives the burner exhaust from the recuperator 42 to remove and recover the water from the exhaust. In order to achieve a steam to carbon ratio of about 1 (for methanol fuel), about ⅓ of the recovered water in the hot side is transferred to the fuel line 29 to be added to the inlet fuel stream 17. Although illustrated with the use of recuperator 42, this is not intended to be limiting since the recuperator 42 may not be used and the water removal system 60 would directly receive the fuel processor 15 exhaust.

Even after the large amount of water is removed and transferred to the inlet fuel stream 17, the water concentration in the hot side is still relatively high (between about 7% to about 20%). This translates into a high concentration gradient to force the water from the hot side of the water removal system 60 into the cold side of the water removal system 60. Under these conditions, the hot side will also transfer sensible heat from the hot side to cold side. This reduces the demand of use on the recuperator 42 and reformer 32 as well as increases overall fuel cell system efficiency. Additionally, the overall exhaust temperature and/or heat dump will be reduced.

FIG. 2B illustrates one embodiment of a water recovery system without a water permeable membrane. High water content gas, such as the burner 30 exhaust, is feed into recuperator inlet 62 in the direction of arrow A. Water removal system 72 has a condenser 73 and wick 70. Heat exchange appendages 62 in condenser 73 may transfer heat, in the direction of arrows B, from the high water content gas into internal cooling fins 66 and/or a heat pipe 68. This cools the high water content gas and condenses out the product water. Product water is then collected or removed from the high water content gas to the wick 70. The wick may be made from any type of porous material that has a large water buffer capability in order to retain the water from the exhaust stream. The wick 70 should also be able to operate at temperatures up to about 100° C. The wick may be any polymer, wool, or any other materials to further retain the remaining water from the exhaust stream.

The wick 70 then feeds the removed product water into water line 74 via pump 76. The removed product water is then added to fuel line 29 for recirculation into the fuel 17 for use in the burner 30. Although illustrated with the removed water added to fuel line 29, this is not intended to be limiting as the removed water may also be added to fuel line 27 for use in the reformer 32.

Since the wick 70 is not gravity dependent, use of the wick 70 allows the fuel cell system to operate in all orientations relative to the ground, such as sideways, up-side down, and the like. Thus, even if the fuel cell system was up-side down, the wick will still be able to remove or wick water from the exhaust.

Typically during startup, reformed fuel cell systems do not require water, therefore during startup, the fuel cell 20 and fuel processor 15 generate product water. The product water is eventually routed into the recuperator 42 and/or water recovery system 72, where the water condenses and collects in the wick 70. This allows reformed fuel cell systems to use pure fuel to startup the system, which reduces the startup time and allows the fuel cell system to start up at below freezing temperatures.

Once water demand is required, a pump 76 can apply a negative pressure to the wick 70 and draw out water stored in the wick 70 to add to the fuel 17. In one example, the water and fuel may be routed to the reformer 32, where it reacts to make hydrogen. This hydrogen is either consumed in the fuel cell 20 or the fuel processor 15 catalytic heater whereupon it reacts with oxygen to form water. The water is then condensed in the recuperator 42 and/or water removal system 72, collected in the wick 70, and the cycle is repeated.
On shutdown, the water and fuel feed as well as the cooling fans are turned off. Shut down occurs when power is no longer required and the fuel cell 20 is turned off. This reduces the heat load on the recuperator 42 and water removal system 72. The exhaust from the burner 30 or reformer 32, may then be used to evaporate and remove all stored water in the fuel cell system, such as any remaining water in the wick 70.
In another embodiment, in the shutdown sequence, the pump 76 may be turned on for a predetermined period of time in order to remove all water from all plumbing in the fuel cell system, including the pump 76 itself. This removes any remaining or free water from the fuel cell system when the system is off, which allows for the storage of the portable fuel cell system in freezing temperatures. Moreover, by emptying out the water on every shutdown cycle, there will be little or no buildup of undesirable materials, such as metal ions, carboxylic acid, dissolved gases, and other contaminates. In another example, during shutdown the air or oxidant supply into the fuel processor may be left on to allow the air or oxidant supply to enter the water removal system and remove or evaporate any remaining liquid water from the wick.

Although illustrated with the water added to the fuel before entering the recuperator 42, this is not intended to be limiting as the water and fuel 17 may be mixed after entering the recuperator 42. This may be based on the miscibility of the water and fuel 17. For example, water and methanol are miscible, but water and JP8 are not. Hence, JP8 and water would be separately fed into the recuperator 42 and only mixed after vaporization in the recuperator 42.

In one embodiment, separate means of controls and instrumentation may be employed to operate the recuperator 42 and the water removal system 72. For example, the pump 76 and fuel pumps 21a,b may be configured with differential pressure type flow meters in order to accurately measure the liquid flow rates. This may provide the exact steam/carbon ratio. In another example, a fuel concentration sensor 78 may be used to accurately feed the reactant liquids. In another example, bubble sensors may be employed to determine the presence of a bubble, and a control system can speed up the pumps 76, 21a,b as necessary to remove the bubble. In still another example, a temperature sensor 80 may be employed at the low water concentration gas exit 83. The temperature reading from the temperature sensor 80 can be used to speed up or slow down the cooling fans 84 until the correct temperature is reached. For example, the temperature may correspond to the dew point required to condense at least the adequate amount of water needed for combination with the fuel.

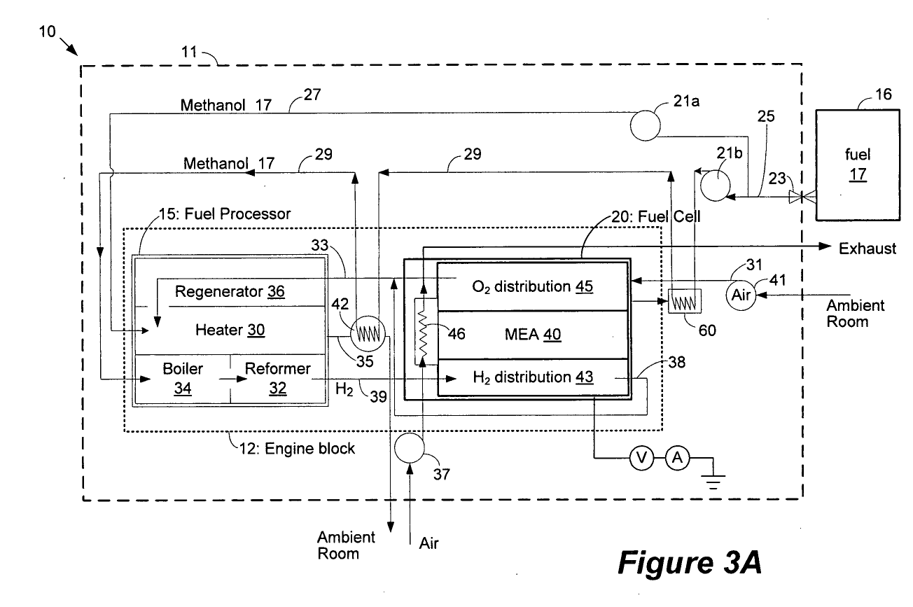

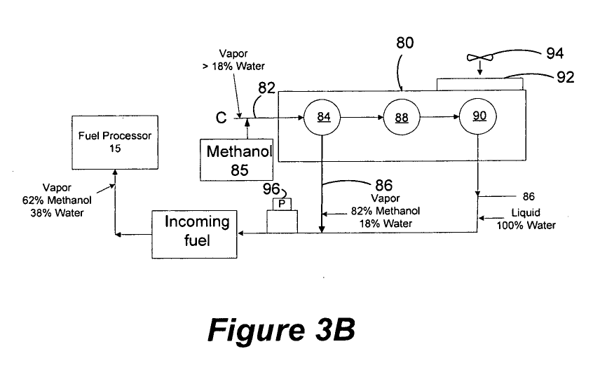

FIGS. 3A and 3B illustrate fuel cell systems having example water removal systems that receive fuel cell exhaust. Referring to FIG. 3A, the water removal system 60 hot side may receive exhaust from the fuel cell 20. In a specific embodiment, this occurs before a system or “dilution” fan stream mixes into the exhaust from the fuel cell 20. The main fuel cell 20 exhaust contains water generated in the fuel cell 20 and is at a relatively cool temperature (for example, between about 100° C. to about 150° C.). When the water permeable membrane is located after the fuel cell 20 exhaust and when system diffuser fan 41 streams have converged, the fuel cell 20 exhaust temperature is typically between about 35° C. to about 70° C. However, while the temperature is low on hot side, the concentration of water in the streams is also relatively low due to the dilution effects of the cooling blower and/or system diffuser fan 41.

Referring to FIG. 3B, an illustration of another embodiment of the water removal system. The water permeable membrane 80 may receive water rich exhaust 82 at arrow C. The water rich exhaust can be received from the fuel processor 15 or the fuel cell 20. The water rich exhaust 82 is fed to membrane 84, where water vapor permeates through and is separated from the exhaust by water permeable membrane 84. The water vapor may be fed through water line 86 to a fuel line to be added to fuel 17.

The exhaust is then passed through the condensing apparatus 88. The condensing apparatus 88 may have a plurality of fans, fin-based heat exchangers, or heat pipes to remove heat from the exhaust and cool the exhaust. A thermoelectric cooling device (TEC) 92 may be in thermal communication with the condensing apparatus 88 to further cool the exhaust, if necessary. The thermoelectric cooling device may condense and remove additional water from the exhaust for collection at wick 90. Thermoelectric cooling device 92 may also have a fan 94 to assist in cooling the exhaust. The thermoelectric cooling device 92 may be powered by an external power source such as the primary fuel cell, a battery, or thermo electric generator.

TECs typically have a coefficient of performance (COP) of 0.5 to 1.5, and therefore if used to condense all the product water, excessive power consumption would be used therefore reducing the efficiency and power output of the fuel cell system. However, when used in conjunction with the water permeable membrane, the TEC power draw will drop because the membrane performs a portion of the water recovery. Depending on the membrane configuration, different amounts of water can be transferred through the membrane. A counter flow arrangement using a simply concentration gradient of water vapor from the hot side to cold side may result in approximately 20% water concentration on the cold side exit. A counter flow arrangement with fuel (e.g. such as methanol 85, as illustrated in FIG. 3B) can be used to sweep the water permeable membrane 84 and condense water on the cold side. This may increase the water concentration on the cold side exit to more than 40% such that the water permeable membrane removes greater than 40% of the required amount of water needed for the portable fuel cell system.

The water recovery process may be completed with use of only the condensing apparatus 88 and the water permeable membrane 84 since use of the thermoelectric device 92 would require additional energy. However, when the ambient temperature is high, for example, above 50° C., activating the thermoelectric device 92 for water recovery may be required. The tradeoff of using the thermoelectric device 92 for recovering water at high ambient temperatures is that the fuel cell system will consume more power.

Water that is condensed may be collected by wick 90. The removed water may then be fed to the incoming fuel 17 via water line 86. A pump 96 may be used to draw the recovered water or water vapor from the water line 86 to the incoming fuel 17. In one embodiment, pump 96 may apply a negative pressure to the water removal system, such as to the water permeable membrane or the wick, to remove the water.

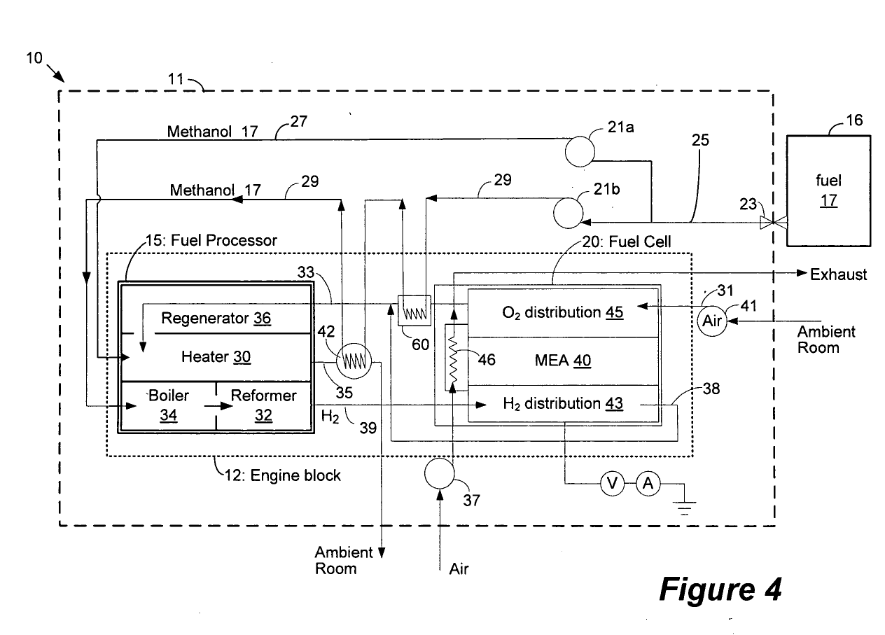

FIG. 4 illustrates a fuel cell system having an example water removal system that receives cathode exhaust. The cathode exhaust stream often contains between about 60% to about 80% of all the fuel cell system product water at a concentration of approximately 6% to about 15%. Thus, using the water removal system 60 to recover water from the cathode exhaust stream may provide another means with which to add water to the fuel 17.

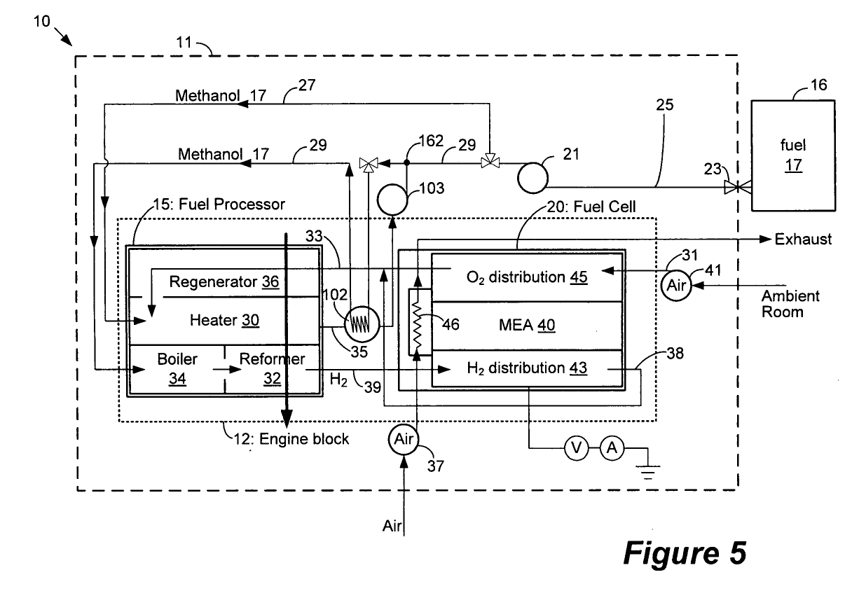

FIG. 5 illustrates a fuel cell system having another embodiment of a water removal system. As mentioned above, water recovery increases energy density of a portable fuel cell system (including the portable system and cartridge). The water permeable member, condenser, and recuperator may be combined to from a single water removal system 102. This provides for a means of accurately recycling condensed water back into the fuel line 29. The use of the wick in the water removal system 102 ensures that the removed water is directed towards the appropriate outlet or water line even when the fuel cell system is not operated in the proper orientation. In other words, the fuel cell system is orientation independent and the removed water is directed towards the appropriate outlet or water line even if the fuel cell system is operated up-side down, sideways, or in any other orientation relative to the ground.

The water recovery system 102 can be located directly downstream of the burner exhaust 35. This simplifies the water recovery process since the burner exhaust 35 has the highest concentration of water. Additionally, the net heat load on the fuel cell system is reduced since the exhaust stream exiting the water recovery system 102 has a lower temperature and mass flow rate. A pump 103 may apply a negative pressure to the water recovery system 102 to pump the water out of the water recovery system 102 to the fuel 17.

Certain higher reforming temperature fuels, such as JP8 and ethanol for example, may require additional heat exchangers located downstream of the burner 30. The heat exchangers may transfer the heat to other system reactors of fluid streams, however the exhaust is still fluidically in line with the burner exhaust 35 where the water concentration is high. Thus, two considerations for locating the water recovery system 102 downstream from the burner 30 exhaust are a) the water content of the process exhaust stream to be cooled, and b) the temperature of the fuel cell system. Higher water content increases the allowable ambient temperature operating capability of the water removal system. Higher gas temperatures increase the water recovery system 102 efficiency.

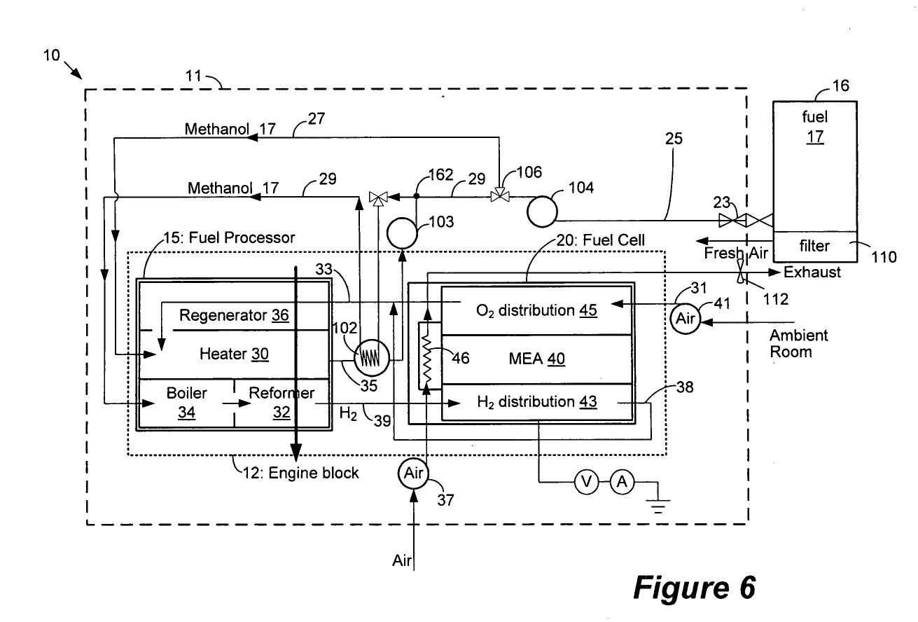

FIG. 6 illustrated an example portable fuel cell system. The portable fuel cell system may have several modifications to increase its reliability and thermal performance. First, the two fuel pumps 21a,b (FIG. 1B) may be replaced with one pump 104 and a 3-way latching valve 106. The 3-way latching valve may be any known valve to direct fuel, such as a model LHLX0500350B, as supplied by The Lee Company of Westbrook, Conn. During fuel processor start-up, the pump 104 supplies fuel from the cartridge 17. The 3-way valve 106 may direct the fuel 17 towards the fuel processor burner 30. Once the fuel processor 15 has reached operating temperature, the 3-way valve may direct the fuel towards the reformer 32. The use of a single fuel pump 104 consumes less power thereby making the overall portable fuel cell system more efficient. Additionally, use of the 3-way valve 106, which is smaller than the fuel pump 104, makes the overall portable fuel cell system smaller and compact.

Also illustrated is another embodiment for supplying filtered cooling air. At least one fan 102 can be configured to pull gaseous products out of the portable fuel cell system and thereby reduce the fuel cell system housing temperature. In a specific embodiment, one or more exhaust cooling fans 112 are located on the fuel cell system package enclosure. The fan 112 is orientated such that the fan sucks air through the fuel cell system, as opposed to pushing air through the package.

One or more intakes may be located on the fuel cell system housing, and at least one filter 110 may be installed on the fuel cartridge 17 and/or on the fuel cell housing and situated adjacent to an air inlet such that air flowing into the fuel cell housing is filtered by the disposable cartridge filter 110. Pulling air through the fuel cell system allows the fans to suck air from all the various nooks and crannies within the fuel system and replaces the heated air with fresh, cool air thereby helping to keep the fuel cell system housing temperature lower. Furthermore, air channels, or an air gap may be disposed within the fuel cell system housing such that intake cooling air is routed through these channels before being expelled by the exhaust fan 112 thereby further cooling the fuel cell system.

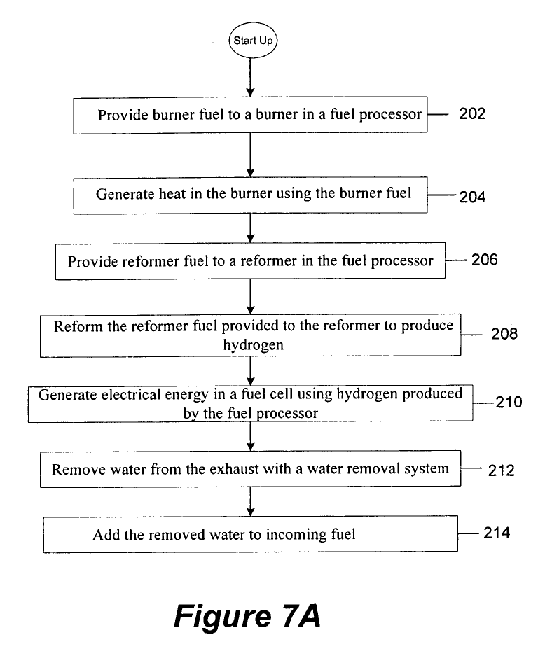

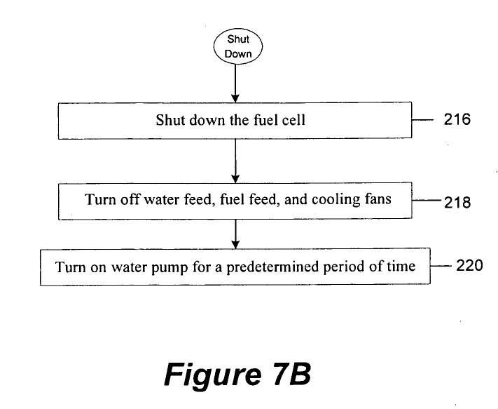

FIGS. 7A and 7B are flow diagrams of a method for recovering water in a portable fuel cell system. Referring to FIG. 7A, upon start up, burner fuel may be provided to the burner in the fuel processor at 202. Heat may then be generated in the burner using the burner fuel at 204. During the startup process, the product water from the startup combustion reaction is condensed and collected in the wick. Once enough water is collected in the wick and the startup process is complete, there is then enough water in the reformer inlet to start reforming the fuel into hydrogen bearing gas. Once the fuel processor has reached operating temperature, reformer fuel may be provided to the reformer in the fuel processor at 206. The reformer reforms the reformer fuel to produce hydrogen at 208. Electrical energy is then generated in the fuel cell using the hydrogen produced by the fuel processor at 210.

Once the fuel cell system reaches steady state, water can be removed from an exhaust at 212. The exhaust may be from the fuel cell or the fuel processor. More specifically, the exhaust may be burner exhaust, reformer exhaust, cathode exhaust, or fuel cell exhaust. The water may be removed using any embodiment of the water recovery systems as described in detail above and will not be discussed in detail herein for brevity. The removed water and water vapor may then be added to incoming fuel before the fuel reaches the reformer or the burner at 214.

Referring now to FIG. 7B, at shut down, when the user no longer needs power, the fuel cell is shut down at 216. The water and fuel feed as well as the cooling fans are turned off at 218. This reduces the heat load on the fuel cell system. Furthermore, exhaust from the fuel cell or fuel processor may be used to evaporate and remove all stored water in the fuel cell system, such as any remaining water in the wick. A pump may be turned on at 220 and configured to apply a negative pressure to the water recovery system for a predetermined period of time in order to remove all water from all plumbing, and the pump itself, including the fuel cell system. This removes any remaining or free water from the fuel cell system when the system is off, which allows for the storage of the fuel cell system in freezing temperatures. Moreover, by emptying out the water on every shutdown cycle, there will be little or no buildup of undesirable materials, such as metal ions, carboxylic acid, dissolved gases, and other contaminates.

Example Results

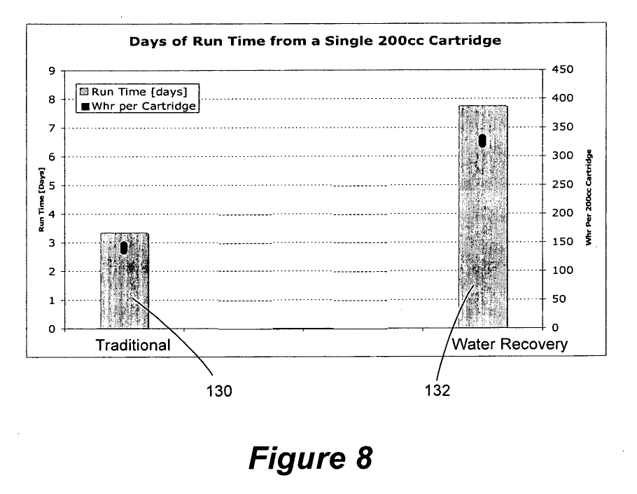

Examples are provided herein for exemplary purposes only and are not intended to be limiting. FIG. 8 is a graph illustrating the days of run time from a single 200 cubic centimeters (cc) cartridge. The systems and methods described herein increase the energy density of a fuel cartridge, and hence offer the user either increased run time for a given amount of fuel or a lighter fuel volume for a given run time. The graph illustrates that the run time for current fuel cell systems 130 is less than the run time for a fuel cell system having a water recovery system 132. The recovery of water may increase efficiency of a fuel processor by between about 5% to about 10% and reduce fuel consumption in the burner. Additionally, the fuel processor may yield about 180 Whr/Kg increase in energy density. As such, removing water from the fuel cell exhaust stream eliminates the amount of water that must be carried by the fuel cartridge.

Thus, an increase in energy density is possible by recycling product water back into the feed stream. In broad terms, all the elemental hydrogen entering the fuel cell system, either in hydrocarbon fuel, pure hydrogen, ammonia, or the like, eventually exits the fuel cell system in product water. Removing this product water and recycling it back into the reformer fuel inlet allows the fuel cell system to gain the benefits of higher energy density fuel and the additional hydrogen generated by the shift reaction of CO:

i.CO+H₂O→CO2+H₂ (4)

Although described and illustrated with the use of specific examples, the examples are not meant to be limiting, as various embodiments may now be known. For example, in each embodiment discussed above, a methanol or fuel concentration sensor 160 (FIG. 8) may be used on the reformer fuel inlet (after the water has been recovered and combined with the fuel) to ensure that a desired methanol concentration is achieved.

In another example, in each embodiment, a fan or blower may be used to control the operating temperature of the water removal system. The fan or blower cools the water removal system such that the required amount of water is condensed on the water removal system hot side. Depending on the type of water permeable membrane used in the water removal system, liquid or vapor phase water may have different diffusion characteristics. In other words, if the water permeable membrane has a higher propensity to diffuse water vapor compared to liquid water, the operating temperature of the water removal system can be controlled such that if the methanol sensor detects too much water in the reformer inlet the fan can be used to cool the water removal system to reduce the amount of water transferred and added to the fuel, and vice versa.

Other control methods can be applied. For example, a temperature sensor may be located on the hot side exhaust and used to calculate a dew point of the hot side stream as a means of controlling the amount of water transferred into the fuel. A control system may have executable instructions to control the pump so as to remove water from the wick for a predetermined period of time at shut down of the fuel cell.

In some cases, the water permeable membrane materials may be selected to provide certain properties that are fuel sensitive. For example, methanol and DME are highly miscible in water. As a result, many commercially available water permeable membranes (which are suitable for use in a water permeable membrane, such as Nafion 117 or Nafion 112 from DuPont) tend to transfer water, DME and methanol equally or similarly. The water permeable membrane works by transferring vapors through which have a concentration gradient from the once side to the other. As described above, there is a large water vapor concentration gradient between a hot and cold side of a water permeable membrane, but there is also a large methanol or DME concentration gradient between the cold side and hot side. Therefore, if Nafion were used in the water recovery system, it is possible that fuel would be transported from the cold to hot side resulting in increased system emissions and increased fuel consumption. Therefore, selection of the water permeable membrane material is application dependant. For example, water permeable membranes supplied by Hokku Scientific of Honolulu, Hawaii or Polyfuel of Mountain View, Calif., may be used since they have been engineered for reduced methanol crossover.

Additionally, other methods of humidification may be applied. These may include the use of enthalpy wheels, condensers and recirculation pumps, and/or tubular or planar type water permeable membrane.

Moreover, other methods of removing the water from the water removal system may also be used, such as with an electroosmotic pump. Electroosmosis may be used to remove the water from the water permeable membrane or wick. In electroosmosis, water is pumped through the water permeable membrane by the application of a voltage. The electroosmotic pumps may be fabricated from silica nanospheres or hydrophilic porous glass. The pumping mechanism can be generated by an external electric field applied to the water permeable membrane to pump the water out of the water permeable membrane.

Adding a water removal system to a portable fuel cell system allows for the use of higher concentration fuels, such as pure methanol, to be used in the fuel processor. This increases the energy density of the fuel cell system. This also permits the use of higher hydrocarbon fuels requiring high steam to carbon ratios, such as JP8, butanol, propanol, methane, isooctane and ethanol, for example. These higher hydrocarbon fuels may be reformed without soot formation or excessive carbon monoxide output.

Fuel Cell System Operation

Fuel cell system 10 has two main phases of operation: a) steady state operation and b) warm-up. System 10 may include other phases, such as a cool down phase, which are not elaborated on for sake of brevity.

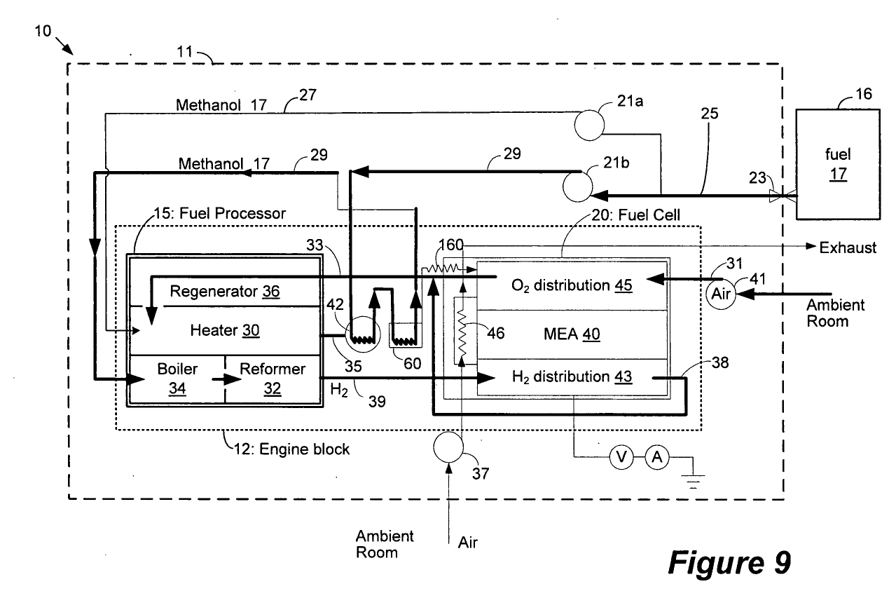

FIG. 9 will be used to show a method 100 for steady state operation of fuel cell system 10 in accordance with one embodiment. Bolded arrows in FIG. 9 show the movement of fluids for steady state operation in system 10.

Steady state operation occurs when the fuel cell 20 generates electrical energy. Typically, fuel cell 20 generates heat during electrical energy generation. Method 100 uses this heat to increase fuel cell system efficiency. As the term is used herein, fuel cell system efficiency refers to the ratio of output energy to input chemical energy of the fuel. Input energy for a fuel cell system can be determined over a set period of time by the energy capacity in fuel 17 and the amount of fuel taken from storage device 16 over the set period of time. Output energy is typically measured by the electrical output of fuel cell 20.

Method 100 begins by providing fuel to a reformer in the fuel processor on lines 25 and 29. Method 100 also pre-heats fuel 17 after the fuel exits storage device 16 and before it enters fuel processor 15. In one embodiment, the preheating employs waste heat in system 10. Waste heat in this sense refers to heat that typically would contribute to inefficiency of the system, such as heat that would escape system package 11. In one embodiment, heat used to warm fuel 17 is carried by a fluid in fuel cell system 10. Fluids (a gas or liquid) suitable for use in this manner may include one or more of: the cathode exhaust from fuel cell 20 in line 33, reformer 32 exhaust from fuel processor 15 in line 39, burner 34 exhaust from fuel processor 15 in line 35 (as shown in FIG. 1B), anode exhaust from fuel cell 20 in line 38, or combinations thereof. Fuel cell 20 and fuel processor 15 both run at elevated temperatures during steady-state operation. Any fluids emitted from fuel cell 20 and fuel processor 15 will also be at elevated temperatures and are suitable for heating the incoming fuel. In one embodiment, the fuel cell 20 may be used to heat the incoming fuel.

The pre-heated fuel is provided into reformer 32 along a second portion of line 29 between the heat exchanger 42 and reformer 32. In this case, the fuel 17 also passes through boiler 34, which boils the fuel if this has already not been accomplished in line 29.

Reformer 32 converts the fuel 17 to reformate gas. Method 100 then feeds the reformate gas to a fuel cell anode where the fuel cell consumes some, but not all, of the hydrogen in the reformate gas for electrochemical energy generation.

The method routes the hydrogen-depleted reformate back to another part of system 10 to use any remaining hydrogen and capitalize on the energy available in the hydrogen. In one embodiment, the fuel cell system plumbs the hydrogen-depleted reformate back to a catalytic heater 30 located in fuel processor 15. The catalytic heater oxidizes the remaining hydrogen to generate heat. The fuel processor is configured to transfer the heat, at least partially, to reformer 32 to supply heat of formation of incoming fuel 17.

Air movement occurs concurrently with the fuel movement in method 100. First, ambient air is provided via a pressure source into the cathode of fuel cell 20. The fuel cell consumes oxygen in the air proportionally to the fuel consumed at the anode. The fuel cell also heats the air, and adds some water in the form of steam. In one embodiment, the air is (pre-) heated to the fuel cell 20 temperature before leaving the fuel cell. In a specific embodiment, fuel cell 20 operates between about 120 degrees Celsius and about 200 degrees Celsius.

For system 10, the oxygen-reduced, steam-enriched, and heated air exits fuel cell 20 and is provided to regenerator 36 in fuel processor 15, where the heated air receives additional heat from heater 30 while in regenerator 36, thereby further reducing the heat load within burner 30. The dually heated air then enters the heater 30 for catalytic heat generation using fuel 17.

Exhaust from heater 30, including the bi-products of the catalytic heat generation, enters line 35, where heat in the exhaust warms incoming fuel 17, as described above using heat exchanger 42, where heat from the exhaust gas is transferred into the liquid fuel 17 inlet to the reformer 32. This heat exchange allows for heated and pre-vaporized fuel 17 to enter a reforming chamber, thereby reducing the heat duty on burner 30 and increasing the system efficiency. During steady state operation, line 35 routes the exhaust, after the exhaust passes through heat exchanger 42, to water removal system 70 to remove water from the exhaust and add the removed water to the incoming fuel line 29, as discussed in detail above.

If needed, a separate fan, blower or other pressure source 37 moves air to the fuel cell 20 for cooling. Embodiments described below also add a heat exchanger to fuel cell 20 that transfers heat from the fuel cell to incoming fuel 17 or incoming air provided to the fuel processor. These embodiments also reduce the amount of cooling done by fan 37.

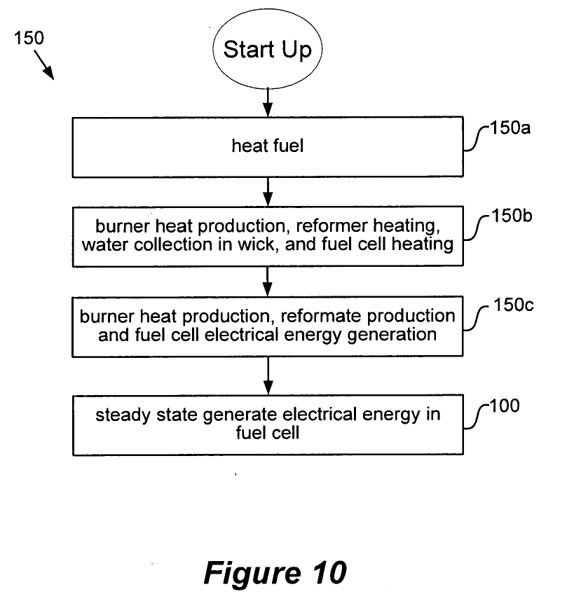

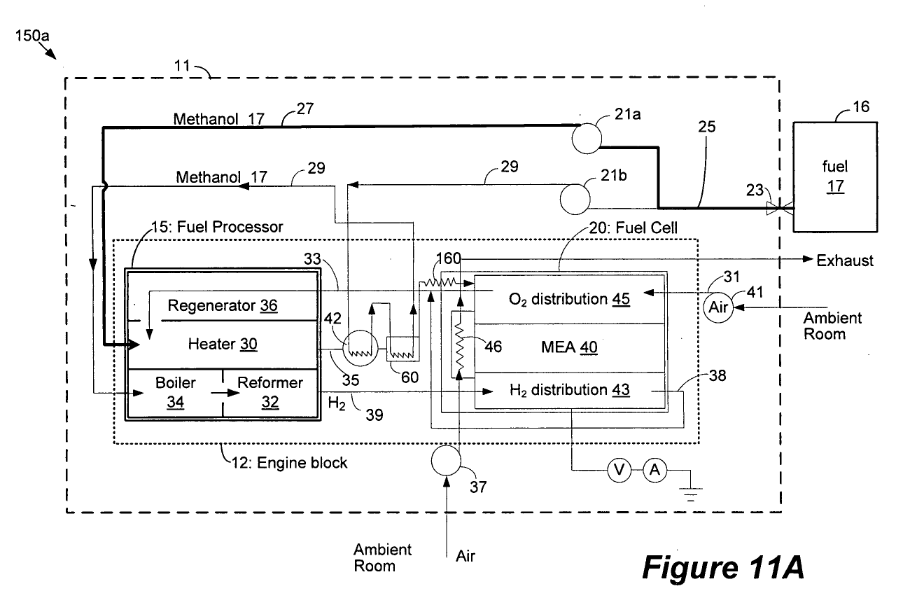

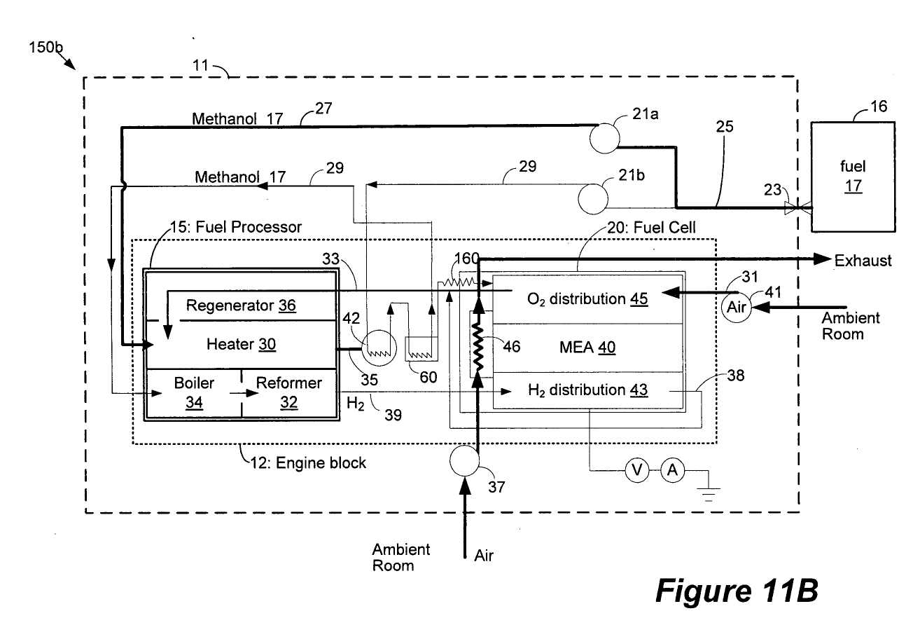

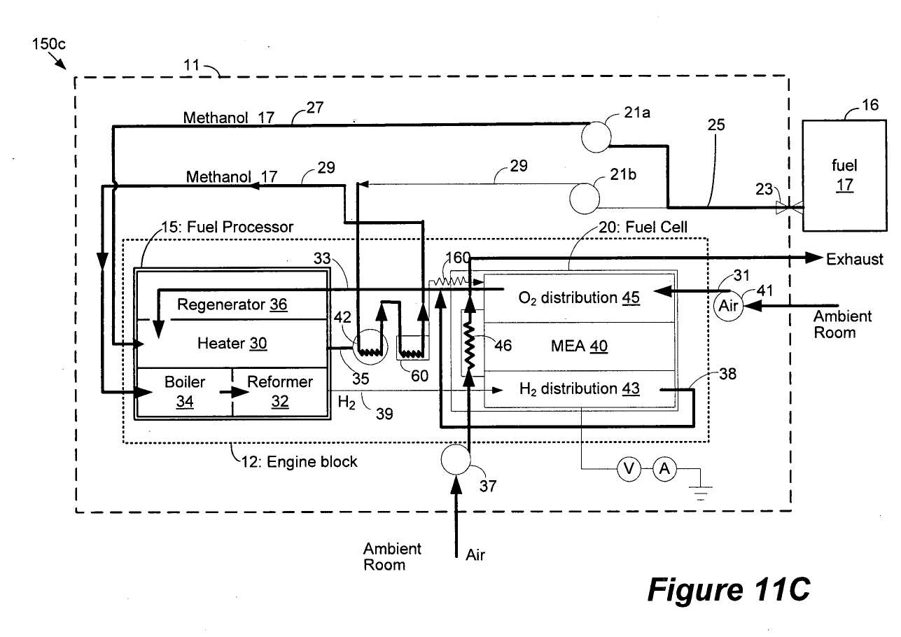

FIG. 10 shows a method 150 for warm-up operation of fuel cell system 10 in accordance with another embodiment. Method 150 is divided into three stages: a) burner fuel heating, b) burner heat production, reformer heating and fuel cell heating, and c) burner heat production, reformate production and initial electrical energy generation in the fuel cell. FIGS. 11A-11C show these three stages in accordance with specific embodiments; bolded arrows in FIG. 11A-11C show the movement of fluids for each stage of method 150.

Fuel cell 20 has a minimum operating temperature. Warm-up method 150 seeks to raise the temperature of fuel cell 20 to this minimum operating temperature. In one embodiment, the minimum operating temperature of fuel cell 20 is greater than about 120 degrees Celsius. In a specific embodiment, the minimum operating temperature of fuel cell 20 is greater than about 160 degrees Celsius.

Warming method 150 may occur at initial start-up, or during intermittent periods of system 10 rest when fuel cell 20 is not generating electrical energy and the fuel cell temperature has dropped below the fuel cell minimum operating temperature. More specifically, when not generating electrical energy, since the ambient room or atmosphere is usually cooler than the fuel cell operating temperature, system 10 and fuel cell 20 loses heat to the ambient environment. Correspondingly, fuel cell 20 cools, and often eventually drops below its minimum operating temperature.

The first stage 150a, or burner fuel heating, begins with fuel 17 provision to the heater 30 in line 29. In one embodiment to facilitate fuel 17 boiling before reaching an internal burner chamber, system 10 includes an electrical heating device configured to heat the incoming burner fuel. The electrical heating device includes one or more heating surfaces that contact the incoming fuel. One suitable resistive electrical heating device may be used. In a specific embodiment, the electrical heating device is activated until the heating surface reaches about 300-500 degrees Celsius. Other heater start temperatures are suitable for use. Methanol 17 in line 27 contacts the heating surface, flash boils, and the resultant methanol vapor mixes with air to form a combustible mixture.

Heater 30 then consumes the vaporized fuel 17 to generate heat. Heat generation in burner 30 also begins stage two, 150b, of FIG. 10. FIG. 11B shows one specific embodiment for this stage. In one embodiment, a burner catalyst in burner 30 then generates heat with fuel 27. Portions of the heat may be provided to the reformer 32, the fuel cell 20, incoming fuel 17, and combinations thereof. Additionally, water from the burner exhaust is collected in the wick. In one embodiment, fuel processor is configured such that heat from burner 30 conducts through common walls shared by burner 30 and reformer 32. In another embodiment, burner 30 surrounds reformer 32 on multiple sides of reformer 32 on to permit heat transfer in multiple directions inwards to reformer 32 and to increase the shared surface area between the two. Further description of a fuel processor suitable for use herein is described in commonly owned patent application Ser. No. 11/313,252 and entitled “Fuel Processor For Use With Portable Fuel Cells” which is incorporated herein by reference in its entirety for all purposes.

During stage two, 150b, exhaust from heater 30 is provided to fuel cell 20 for catalytic heating of the fuel cell. Additionally, water from the burner exhaust is collected in the wick. In one embodiment, fuel cell 20 includes a thermal catalyst in thermal communication with the fuel cell. For system 10, the fuel cell includes a heat transfer appendage 46 in conductive thermal communication with an externally arranged thermal catalyst and internal portions of the fuel cell. The heat transfer appendages permit conductive heat transfer from the externally arranged thermal catalyst into the fuel cell, which expedites fuel cell heating and start up times. A fan, blower or other pressure source 37 moves air to the fuel cell 20 for reaction with the fuel and thermal catalyst. Ideally, any remaining fuel or hydrogen in the exhaust is oxidized to generate heat, but this is not a requirement. Further description of catalytic heating of a fuel cell and heat transfer appendage 46 is provided in commonly owned patent application Ser. No. 11/314,810, entitled “Heat Efficient Portable Cell Systems”, which is incorporated herein by reference in its entirety for all purposes. Other techniques to heat the fuel cell are also suitable for use, such as resistive heating with a resistive element.

In a specific embodiment during stage two 150b of method 150 that includes both heat exchanger 42 and fuel cell catalytic heating using the burner exhaust, the heater exhaust bypasses heat exchanger 42. This embodiment can expedite fuel cell warm-up time.

Fuel provision in line 27 and heat generation in burner 30 continues until the fuel processor 15, or some portion thereof such as reformer 32, reaches a minimum operating temperature and/or the fuel cell reaches its minimum operating temperature. In a specific embodiment, the condensing point of reformate gas represents the minimum operating temperature for reformer 32 or fuel processor 15. In another specific embodiment, fuel processor 15 includes a minimum operating temperature between about 240 and about 300 degrees Celsius. A sensor may be included in reformer 32 or fuel processor 15 to detect the desired temperature. Other fuel processor start temperatures are suitable for use. As one of skill in the art will appreciate, the fuel processor 15 minimum operating temperature may vary with the thermal catalyst used in heater and fuel 17 type.

Stage three, 150c, of method 150 begins when the fuel processor and/or the fuel cell reaches a minimum operating temperature (see FIG. 11C). In a specific embodiment, fuel cell system 10 runs dirty reformate through the fuel cell stack and reforming in fuel processor 15 begins before electrical energy generation in fuel cell 20. The dirty reformate is then routed back to fuel processor in line 38 for catalytic heat generation of the hydrogen using a catalyst in burner 30.

For hydrogen production, line 27 transports fuel 17 into reformer 32. A catalyst in reformer 32 helps convert the fuel 17 into a hydrogen rich gas stream, or reformate. The reformate passes in line 39 to fuel cell 20, where electrical energy generation occurs.

Inlet reformer fuel in line 29 also passes through heat exchanger 42. As mentioned before, incoming fuel 17 to reformer 32 is vaporized before processing by a reforming catalyst in the reformer. (Similarly, incoming methanol to burner 30 is vaporized before meeting the burner catalyst.) The fuel 17 typically enters the fuel cell package at its storage temperature in storage device 16, such as the ambient temperature surrounding the fuel cell system, which is normally cooler than the operating temperatures of fuel cell 20 and fuel processor 15, or fluids emitted from these devices. Any heat transferred to fuel 17 before vaporization of fuel in fuel processor 15 (in the burner or reformer) reduces the amount of energy that heater 30 in fuel processor 15 supplies to the cold fuel in the reformer chamber or burner chamber. This pre-heating of fuel 17 increases efficiency by i) leaving more heat for the reformer and catalytic production of hydrogen and thereby consuming less fuel to heat fuel processor 15, and ii) using waste heat from the burner exhaust that might otherwise leave the system. For heat exchanger 42, this also reduces the burner exhaust temperature leaving package 11. If an electrical heater is used to vaporize the incoming methanol, heat exchanger 42 also reduces electrical energy used by the electrical heater to vaporize the incoming fuel.

Line 39 transports the reformate to the fuel cell 20 anode. During warm-up method 150, fuel cell 20 consumes a small amount of hydrogen at the anode, which produces a small load applied to keep the average fuel cell voltage less than 0.75V/cell. This may reduce carbon corrosion in fuel cell 20.

Reformate then is fed back in line 38 from the fuel cell to the burner 30 in fuel processor 15 where some fuel is oxidized (rich mixture), releasing heat into the fuel processor. In a specific embodiment, the amount of unused hydrogen in line 38 is determined by a temperature measured by a sensor included in the fuel processor.

Finally, the hot burner exhaust passes through the heat exchanger 42 and into water removal system 60 to remove water from the exhaust.

Stage three, 150c, of method 150 continues until fuel cell 20 reaches its minimum operating temperature. At this point, full energy generation in the fuel cell begins, which is exothermic, and the system transitions to method 100.

An alternative energy source such as a battery or capacitor, located internal or external to a packaged fuel cell system, may supply power to the load while the fuel cell is warming up. When the fuel cell 20 reaches its minimum operating temperature, the fuel cell may then recharge the battery or capacitor.

Method 150 permits fast start times from a resting temperature. Resting temperature refers to when the fuel cell system and its constituent components matches the temperature of the ambient environment. In one embodiment, method 150 permits fuel cell 20 to begin electrical energy generation in less than about twelve minutes, measured from one of: a) the time that a user requests power from the system 10 to the time that fuel cell 20 powers a load for the user, or b) the time that the fuel processor begins heating cold fuel (e.g., fuel at ambient temperature) to electrical energy production in the fuel cell. In a specific embodiment, fuel cell 20 begins electrical energy generation in less than about 10 minutes. On start up, a fuel processor using neat methanol oxidizes pure methanol, as opposed to a blend of methanol and water. The fuel processor using neat methanol starts up approximately one minute faster, which is 31% faster than the fuel processor using conventional methanol/water fuel blend.

The start time may also vary with the temperature of the ambient environment. Notably, however, fuel cell system 10 and method 150 permit ‘cold starting’. Cold starting refers to starting a fuel cell or fuel cell system from an initial temperature of a fuel cell system (and its constituent components) that is less than about 0 degrees Celsius, or the freezing point of water. In other words, fuel cell system is suitable for use when left in freezing conditions. Many conventional fuel cell systems are typically restricted from this practice since: a) they employ water, and freezing and expanding of the water may lead to structural damage; and/or b) start-up of the fuel cell system requires movement of water, which, again, is frozen, before the system becomes hot. System 10, however, does not suffer from such draw backs and permits repeated transition above and below 0 degrees Celsius. In one embodiment, method 150 permits system 10 to begin from temperatures less than about 0 degrees Celsius. Start-up times in this case may be less than about 20 minutes. Increasing the size of burner 30 may also reduce the startup time to less than 10 minutes. In a specific embodiment, method 150 permits system 10 to begin from temperatures less than about 30 degrees Celsius. Start-up time in this case may be less than 20 minutes. Of course, longer start times may be used.

In accordance with the embodiments of water recovery systems discussed above, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

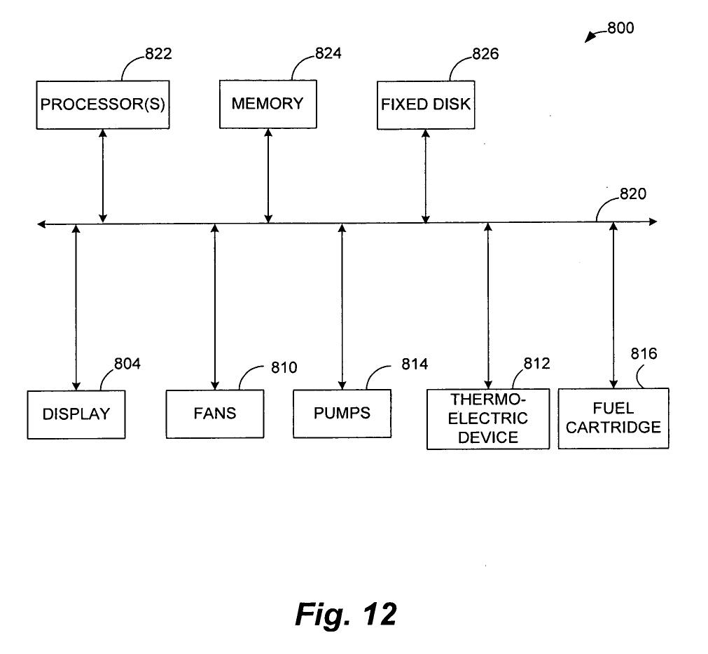

FIG. 12 illustrates an example computer system suitable for implementing the software applications used in one or more embodiments of recovering water in a portable fuel cell system. FIG. 12 shows one possible form of the computer system 800. Of course, the computer system may have many physical forms ranging from an integrated circuit, a printed circuit board, or the like.

Attached to system bus 820 is a wide variety of subsystems. Processor(s) 822 (also referred to as central processing units, controller, CPUs, or the like) are coupled to storage devices, including memory 824. Memory 824 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 826 is also coupled bi-directionally to CPU 822; it provides additional data storage capacity and may also include any of the computer-readable media described below. Fixed disk 826 may be used to store programs, data, and the like and is typically a secondary storage medium (such as a hard disk) that is slower than primary storage. It will be appreciated that the information retained within fixed disk 826 may, in appropriate cases, be incorporated in standard fashion as virtual memory in memory 824.

CPU 822 is also coupled to a variety of input/output devices, such as display 804, fans 810, pumps 814, thermoelectric device 812, fuel cartridge 816, and the like.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level of code that are executed by a computer using an interpreter. Computer readable media may also be computer code transmitted by a computer data signal embodied in a carrier wave and representing a sequence of instructions that are executable by a processor.

While embodiments and applications of this invention have been shown and described, it would be apparent to those skilled in the art having the benefit of this disclosure that many more modifications than mentioned above are possible without departing from the inventive concepts herein.

What is claimed is:

1. A portable fuel cell system for producing electrical energy included in a portable package, the portable fuel cell system comprising:
a fuel processor having:
a reformer configured to receive fuel and to output hydrogen and reformer exhaust, and
a burner configured to receive fuel, to generate heat using the fuel, and to output burner exhaust;
a fuel cell configured to produce electrical energy using hydrogen output by the reformer;
at least one fuel line, internal to the portable package, configured to transport fuel to the reformer or burner; and
a water removal system, including:
a water permeable membrane configured to receive an exhaust and configured to remove water from the exhaust; and
a condensing apparatus including a condenser and a wick, the condensing apparatus configured to receive the exhaust after the water permeable membrane and configured to remove water from the exhaust;
at least one water line, internal to the portable package, configured to transport the water removed by the water permeable membrane and the condensing apparatus to the at least one fuel line, wherein the removed water is added to the fuel.

2. The portable fuel cell system of claim 1, wherein the water removal system further comprises a thermoelectric cooler in thermal communication with the condensing apparatus, the thermoelectric cooler configured to remove heat from the water removal system.

3. The portable fuel cell system of claim 2, wherein the thermoelectric cooler further comprises a fan.

4. The portable fuel cell system of claim 1, wherein the water permeable membrane removes greater than 40% of the required amount of water for the fuel cell system.

5. The portable fuel cell system of claim 1, wherein the water permeable membrane is configured to receive the burner exhaust stream or the reformer exhaust stream.

6. The portable fuel cell system of claim 1, wherein the water permeable membrane is configured to receive a fuel cell exhaust stream.

7. The portable fuel cell system of claim 6, wherein the fuel cell further comprises a cathode and an anode, and wherein the water permeable membrane is configured to receive a cathode exhaust stream.

8. The portable fuel cell system of claim 1, wherein the water removal system further comprises a pump that is configured to apply a negative pressure to the wick.

9. The portable fuel cell system of claim 8, further including a control system that includes instructions that control the pump so as to remove water from the wick for a predetermined period of time at shut down of the fuel cell.

10. The portable fuel cell system of claim 1, wherein the burner exhaust dries the wick at shut down of the fuel cell.

11. The portable fuel cell system of claim 1, wherein the water removal system is configured to receive burner exhaust on startup of the fuel processor.

12. The portable fuel cell system of claim 1, wherein the portable package is configured to operate at any orientation relative to the ground.

13. The portable fuel cell system of claim 1, further comprising a heat exchanger configured to transfer heat generated in the fuel cell or generated in the fuel processor to the incoming fuel that includes the reformer fuel or the burner fuel.

14. The portable fuel cell system of claim 13, wherein the heat exchanger further comprises a heat pipe, internal to the portable fuel cell package, configured to remove heat from the burner exhaust stream or the fuel cell exhaust stream.

15. A method for recovering water in a portable fuel cell system, comprising:
providing burner fuel to a burner in a fuel processor;
generating heat in the burner using the burner fuel;
providing reformer fuel to a reformer in the fuel processor;
reforming the reformer fuel provided to the reformer to produce hydrogen;
generating electrical energy in a fuel cell using hydrogen produced by the fuel processor;
removing water from an exhaust with a water removal system that includes a water permeable membrane and a condensing apparatus, the water permeable membrane configured to receive the exhaust and configured to remove water from the exhaust, and the condensing apparatus including a condenser and a wick and configured to remove water from the exhaust after the water permeable membrane has removed water from the exhaust; and
adding the removed water to a fuel line before fuel in the fuel line reaches the reformer or the burner.

16. The method of claim 15, further comprising pumping water out of the membrane humidifier with a pump for a predetermined period of time during shut down of the fuel cell.

17. The method of claim 15, further comprising evaporating the removed water from the wick on shutdown of the portable fuel cell system with the exhaust from the fuel processor or fuel cell.

18. The method of claim 15 further comprising removing heat from the exhaust with a thermoelectric cooler.

19. The method of claim 15, wherein the exhaust is a fuel processor exhaust or a fuel cell exhaust.

20. The method of claim 19, wherein the fuel cell exhaust is a cathode exhaust.

21. The method of claim 19, wherein the fuel processor exhaust is a burner exhaust.

22. The method of claim 15, further comprising operating the portable fuel cell system in any orientation relative to the ground.

23. The method of claim 15, further comprising transferring heat from an exhaust of the fuel cell or an exhaust of the fuel processor to a heat exchanger.

24. The method of claim 23, wherein the heat exchanger further comprises a heat pipe configured to remove heat from the exhaust.

25. A program storage device readable by a machine tangibly embodying a program of instructions executable by the machine to perform a method for recovering water in a portable fuel cell system, the method comprising:
providing burner fuel to a burner in a fuel processor;
generating heat in the burner using the burner fuel;
providing reformer fuel to a reformer in the fuel processor;
reforming the reformer fuel provided to the reformer to produce hydrogen;
generating electrical energy in a fuel cell using hydrogen produced by the fuel processor;
removing water from an exhaust with a water removal system that includes a water permeable membrane and a condensing apparatus, the water permeable membrane configured to receive the exhaust and configured to remove water from the exhaust, and the condensing apparatus including a condenser and a wick and configured to remove water from the exhaust after the water permeable membrane has removed water from the exhaust; and
adding the removed water to a fuel line before fuel in the fuel line reaches the reformer or the burner.

26. A portable fuel cell system for producing electrical energy included in a portable package, the portable fuel cell system comprising:
a fuel processor having:
a reformer configured to receive fuel and to output hydrogen using the fuel source, and
a burner configured to receive fuel, to generate heat using the fuel, and to output burner exhaust;
a fuel cell configured to produce electrical energy using hydrogen output by the reformer;
at least one fuel line, internal to the portable package, configured to transport fuel to the reformer or burner; and
a water removal system including:
a water permeable membrane configured to receive the burner exhaust and configured to remove water from the burner exhaust;
a condensing apparatus including a condenser and a wick, the condensing apparatus configured to receive the burner exhaust after the water permeable membrane and configured to remove water from the burner exhaust;
at least one water line, internal to the portable package, configured to transport the water removed by the water permeable membrane and the condensing apparatus to the at least one fuel line, wherein the removed water is added to the fuel.

27. The portable fuel cell system of claim 26, wherein the water removal system further comprises a thermoelectric cooler in thermal communication with the condensing apparatus, the thermoelectric cooler configured to remove heat from water removal system.

28. The portable fuel cell system of claim 27, wherein the thermoelectric cooler further comprises a fan.

29. The portable fuel cell system of claim 26, wherein the water removal system further comprises a pump that is configured apply a negative pressure to the water permeable membrane and wick.

30. The portable fuel cell system of claim 29, further including a control system that includes instructions that control the pump so as to remove water from the water permeable membrane and wick for a predetermined period of time at shut down of the fuel cell.

31. The portable fuel cell system of claim 26, drying the wick with the burner exhaust at shut down of the fuel cell.

32. The method of claim 30, further comprising operating the portable fuel cell system in any orientation relative to the ground.

33. The portable fuel cell system of claim 26, further comprising a heat exchanger configured to transfer heat generated in the fuel processor to the incoming fuel that includes the reformer fuel or the burner fuel.
